(19) United States
(12) Patent Application Publication
(10) Pub. No.: US 2014/0172423 A1
(43) Pub. Date: Jun. 19, 2014

(54) SPEECH RECOGNITION METHOD, DEVICE AND ELECTRONIC APPARATUS

(71) Applicant: Lenovo (Beijing) Co., Ltd., Beijing (CN)

(72) Inventors: Haisheng Dai, Beijing (CN); Youlong Lu, Beijing (CN); Qianying Wang, Beijing (CN); Xiangyang Li, Beijing (CN)

(73) Assignee: Lenovo (Beijing) Co., Ltd., Beijing (CN)

(21) Appl. No.: 14/104,402

(22) Filed: Dec. 12, 2013

(30) Foreign Application Priority Data
Dec. 14, 2012 (CN) 201210545922.1

(51) Int. Cl. G10L 21/16

(52) U.S. Cl. CPC G10L 21/16
USPC 704/231

(57) ABSTRACT

A speech recognition method, device and electronic apparatus are provided. The method includes: receiving a speech input, recognizing the speech input as a wake-up instruction by a wake-up engine, waking up a search engine according to the wake-up instruction, and determining a recognition scope corresponding to the wake-up instruction. The recognition scope corresponding to the wake-up instruction, compared with the entire recognition scope of the recognition engine, is relatively small. Hence, the recognition scope of the recognition engine is narrowed. Compared with the search within a large recognition scope, the precision in searching the target is improved by searching within a relatively small scope.

This application claims the priority for Chinese Patent Application No. 201210545922.1, entitled “SPEECH RECOGNITION METHOD, DEVICE AND ELECTRONIC APPARATUS”, filed with the Chinese Patent Office on Dec. 14, 2012, which is incorporated by reference in its entirety herein.

### FIELD

The present disclosure relates to the field of mode recognition, and particularly to a speech recognition method, device and electronic apparatus.

### BACKGROUND

At present, the speech recognition technology is being more and more widely used. An existing speech recognition method which is applicable in an intelligent TV set usually includes: firstly receiving a wake-up instruction input by a user to wake up a speech control mode according to the wake-up instruction, searching for an object according to a speech instruction of the user, and displaying the searched object to the user. For example, an intelligent TV set receives a wake-up instruction of a “speech assistant” which is input by a user, and then enters into the speech control module. Next, the intelligent TV set receives the user's speech of “Journey to the West”, and displays objects relevant to “Journey to the West” to the user. Generally, in the existing speech recognition method, the search scope of a recognition engine is so huge that the obtained search result generally lacks of precision, which therefore can not meet the user's requirement.

### SUMMARY

In view of this, a speech recognition method, device and electronic apparatus are provided in the embodiments of the present disclosure to solve the problem of lacking of precision in the existing speech recognition method.

To address this issue, the following technical solutions are provided in the embodiments of the present disclosure.

A speech recognition method applied to an electronic apparatus, including:

receiving a speech input;

recognizing the speech input as a wake-up instruction by a wake-up engine; and

waking up a recognition engine according to the wake-up instruction, wherein the recognition engine is adapted to determine a recognition scope which corresponds to the recognition instruction and includes M recognition items, and wherein the recognition engine includes N recognition items, M is smaller than N, and both M and N are integers larger than or equal to one,

wherein in the case that the wake-up instruction is a first wake-up instruction, the recognition engine determines a first recognition scope which corresponds to the first wake-up instruction and includes M1 recognition items, and

in the case that the wake-up instruction is a second wake-up instruction, the recognition engine determines a second recognition scope which corresponds to the second wake-up instruction and includes M2 recognition items, wherein both M1 and M2 are integers smaller than N.

Preferably, the method further includes:

turning off the wake-up engine after the recognition engine is waked up according to the wake-up instruction.

Preferably, the method further includes:

acquiring a recognition instruction input by a user; and

obtaining, according to the recognition instruction, a recognition result within the recognition scope which corresponds to the wake-up instruction and includes M recognition items.

Preferably, after the obtaining the search result, the method further includes:

turning on the wake-up engine in a case where the wake-up engine is in a turned-off state.

Preferably, the method further includes:

restoring the speech input by echo cancellation technique in a case where the electronic apparatus is playing an audio when receiving the speech input; and

turning off or turning down a volume of the audio played by the electronic apparatus in the case that the electronic apparatus is playing the audio after waking up a recognition engine according to the wake-up instruction.

Preferably, the recognition engine includes:

a local recognition engine; or,

a cloud recognition engine.

A speech recognition device applied to an electronic apparatus, including:

a speech receiving module adapted to receive a speech input;

an instruction acquisition module adapted to recognize the speech input as a wake-up instruction by a wake-up engine; and

a determination module adapted to wake up a recognition engine according to the wake-up instruction, wherein the recognition engine is adapted to determine a recognition scope which corresponds to the wake-up instruction and includes M recognition items, wherein the recognition engine includes N recognition items, M is smaller than N, and M and N are integers larger than or equal to one,

wherein in the case that the wake-up instruction is a first wake-up instruction, the recognition engine determines a first recognition scope which corresponds to the first wake-up instruction and includes M1 recognition items, and

in the case that the wake-up instruction is a second wake-up instruction, the recognition engine determines a second recognition scope which corresponds to the second wake-up instruction and includes M2 recognition items, wherein both M1 and M2 are integers smaller than N.

Preferably, the device further includes:

a first control module adapted to turn off the wake-up engine after the recognition engine is waked up according to the wake-up instruction.

Preferably, the device further includes:

a recognition module adapted to acquire a recognition instruction input by a user; and obtain, according to the recognition instruction, a recognition result within the recognition scope which corresponds to the wake-up instruction and includes M recognition items.

Preferably, the device further includes:

a second control module adapted to turn on the wake-up engine in a case where the wake-up engine is in a turned-off state.

Preferably, the device further includes:

an echo cancellation module adapted to restore the speech input by echo cancellation technique in a case where the electronic apparatus is playing an audio when receiving the speech input; and

a volume control module adapted to turn off or turn down a volume of the audio played by the electronic apparatus in a case where the electronic apparatus is playing the audio after waking up a recognition engine according to the wake-up instruction.

An electronic apparatus, including:

an input-output interface adapted to receive a speech input; and

a processor adapted to recognize the speech input as a wake-up instruction by a wake-up engine, and wake up a recognition engine according to the wake-up instruction, wherein the recognition engine is adapted to determine a recognition scope which corresponds to the wake-up instruction and includes M recognition items, wherein the recognition engine includes N recognition items, M is smaller than N, and M and N are integers larger than or equal to one,

wherein in the case that the wake-up instruction is a first wake-up instruction, the recognition engine determines a first recognition scope which corresponds to the first wake-up instruction and includes M1 recognition items, and

in the case that the wake-up instruction is a second wake-up instruction, the recognition engine determines a second recognition scope which corresponds to the second wake-up instruction and includes M2 recognition items, wherein both M1 and M2 are integers smaller than N.

Embodiments of the present disclosure provide a speech recognition method, device and electronic apparatus. The method includes: receiving a speech input, recognizing the speech input as a wake-up instruction by a wake-up engine, determining a recognition scope corresponding to the wake-up instruction when waking up the search engine through the wake-up instruction. Compared with the entire recognition scope of the recognition engine, the recognition scope corresponding to the wake-up engine is relatively small, thus narrowing the recognition scope of the recognition engine. The precision to search a target within a small scope is higher compared with that within a large recognition scope.

### BRIEF DESCRIPTION OF THE DRAWINGS

In order to give a clearer illustration of technical solutions provided in the present disclosure or in the prior art, a brief introduction to the drawings to be used in the description of the embodiments and the prior art is given as follows. Apparently, the drawings referred to in the following description are not the entire but just part of the embodiments of the present disclosure. Other drawings may be gained by those with ordinary skills in the art according to these drawings without any creative work.

FIG. 1 is a flow chart of a speech recognition method according to an embodiment of the present disclosure;

FIG. 2 is a flow chart of a speech recognition method according to another embodiment of the present disclosure;

FIG. 3 is a flow chart of a speech recognition method according to another embodiment of the present disclosure;

FIG. 4 is a flow chart of a speech recognition method according to another embodiment of the present disclosure;

FIG. 5 is a schematic structural diagram of a speech recognition device according to an embodiment of the present disclosure;

FIG. 6 is a schematic structural diagram of a speech recognition device according to another embodiment of the present disclosure; and

FIG. 7 is a schematic structural diagram of an electronic apparatus according to an embodiment of the present disclosure.

### DETAILED DESCRIPTION

The embodiments of the present disclosure disclose a speech recognition method, device and electronic apparatus thereof, aiming at narrowing the recognition scope of a recognition engine according to a wake-up instruction at the same time of waking up the recognition engine by the wake-up instruction. Compared with the huge amount of items to be recognized, speech recognition within a small scope is of higher precision, and therefore can improve speech recognition precision.

Clear and full descriptions of technical solutions provided in the embodiments of the present disclosure in conjunction with the drawings are given as follows. Apparently, embodiments described hereunder are not the entire but just part of the embodiments of the present disclosure. All the other embodiments that can be gained by those with ordinary skills in the art based on the embodiments of the present disclosure without creative work should belong to the scope of protection sought for in the present disclosure.

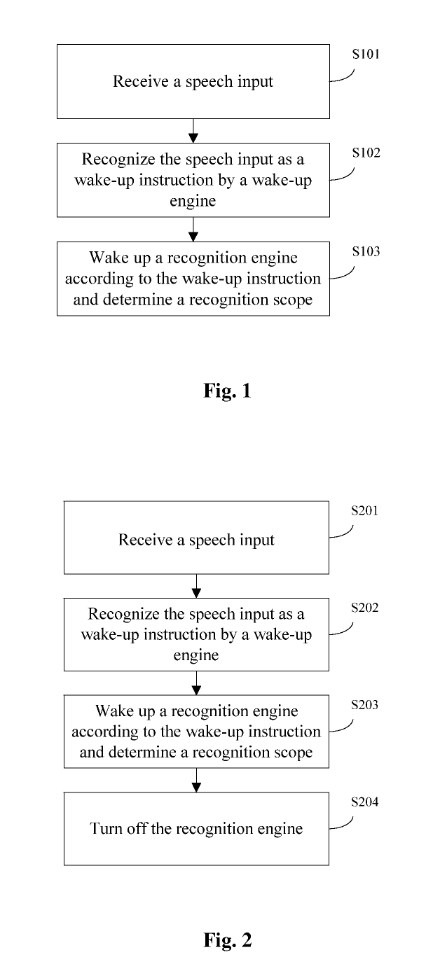

An embodiment of the present disclosure provides a speech recognition method applied to an electronic apparatus, as shown in FIG. 1. The method includes steps S101-S103.

S101: receiving a speech input.

In this embodiment, a speech may be a sound made by a user, and the speech input may be received by an audio acquisition device of the electronic apparatus.

S102: recognizing the speech input as a wake-up instruction by a wake-up engine.

The wake-up engine is an engine of the electronic apparatus for triggering a speech recognition. After receiving the speech, the wake-up engine may determine that the received speech is a preset triggering password, and then the speech would be determined as a wake-up instruction.

It shall be noted that different from a wake-up instruction in the existing way of speech recognition, the wake-up instruction in this embodiment is not only adapted to wake up a speech recognition engine, but also adapted to distinguish the different recognition scopes.

S103: waking up a recognition engine according to the wake-up instruction to enable the recognition engine to determine a recognition scope which corresponds to the recognition instruction and contains M recognition items, where the recognition engine includes N recognition items, M is smaller than N, and both M and N are integers larger than or equal to one.

When the wake-up instruction is a first wake-up instruction, the recognition engine determines a first recognition scope which corresponds to the first wake-up instruction and contains M1 recognition items. When the wake-up instruction is a second wake-up instruction, the recognition engine determines a second recognition scope which corresponds to the second wake-up instruction and contains M2 recognition items, where both M1 and M2 are integers smaller than N.

That is, different wake-up instructions correspond to different recognition scopes. In a case of different wake-up instructions, the recognition scopes determined by a recognition engine are different. The amount of recognition items within different recognition scopes may be the same or different. That is, M1 and M2 may be the same or different, both of which are smaller than the amount of all the recognition items of the recognition engine, i.e., N. For example, a recognition type instructed by the wake-up instruction “I want to watch video” is “video”, and a recognition type scope instructed by the wake-up instruction “I want to listen to music” is “music”.

An intelligent TV set is taken hereunder as an executive body for an exemplary illustration of the method according to this embodiment.

In the prior art, an intelligent TV set receives a user's speech input of “speech assistant”, recognizes speech data as a wake-up instruction by a wake-up engine, and wakes up a recognition engine according to the wake-up instruction. Next, the recognition engine executes a speech recognition among all the recognition items according to speech data further input by a user.

In the method described in this embodiment, an intelligent TV set acquires speech input of a user by a microphone. When acquiring the user's speech input of “I want to watch video”, the intelligent TV set recognizes the speech input of “I want to watch video” as a wake-up instruction by a wake-up engine, and wakes up the recognition engine according to the wake-up instruction. In the step of waking up a recognition engine, the “video” in the speech indicates a recognition scope, and the recognition engine may determine a scope which corresponds to the wake-up instruction and includes M video recognition items as a recognition scope. Compared with recognition among all the recognition items of the recognition engine, the recognition scopes is narrowed according to the solution of the disclosure, which is equivalent to filter the recognition scope before recognition, and the recognition precision is therefore improved.

Furthermore, when acquiring the user's speech input of “I want to listen to music”, the intelligent TV set wakes up the recognition engine, determines a recognition scope corresponding to “music” at the same time, and then executes the recognition within the scope of “music”. In this way, different wake-up instructions may be pre-defined with respect to different recognition scopes to narrow the scope of the speech recognition.

In the speech recognition method according to this embodiment, a wake-up engine wakes up a recognition engine, and the recognition engine may determine a current recognition scope among all the recognition items according to the wake-up instruction at the same time. Compared with a large recognition scope, a small scope may obtain a recognition result of a higher precision, and therefore the speech recognition method described in this embodiment has the advantage of higher recognition precision.

Another embodiment of the present disclosure provides a speech recognition method applied to an electronic apparatus. The electronic apparatus may include a speech acquisition function, a wake-up function and a recognition function. As shown in FIG. 2, the method includes steps S201-S204.

S201: receiving a speech input.

S202: recognizing the speech input as a wake-up instruction by a wake-up engine.

S203: waking up a recognition engine according to the wake-up instruction to enable the recognition engine to determine a recognition scope which corresponds to the wake-up instruction and includes M recognition items, where the recognition engine includes N recognition items, M is smaller than N, and both M and N are integers larger than or equal to one.

When the wake-up instruction is a first wake-up instruction, the recognition engine determines a first recognition scope which corresponds to the first wake-up instruction and includes M1 recognition items.

When the wake-up instruction is a second wake-up instruction, the recognition engine determines a second recognition scope which corresponds to the second wake-up instruction and includes M2 recognition items, where both M1 and M2 are integers smaller than N.

In this embodiment, the recognition engine may be a local recognition engine or a network recognition engine. Either the local recognition engine or the network recognition engine may implement the recognition locally and/or via network, which shall not be limited here.

S204: turning off the wake-up engine.

The speech recognition method described in this embodiment differs from that in the aforementioned embodiment in that, the method includes turning off the wake-up engine after the recognition engine is waken up. In this way, on one hand, the further power consumption of the wake-up engine can be avoided, and hence the aim of energy saving may be achieved. On the other hand, the acquisition of the speech input and the wake-up of a recognition engine can be avoided during the speed recognition, and hence the interference to the current speech recognition process can be avoided.

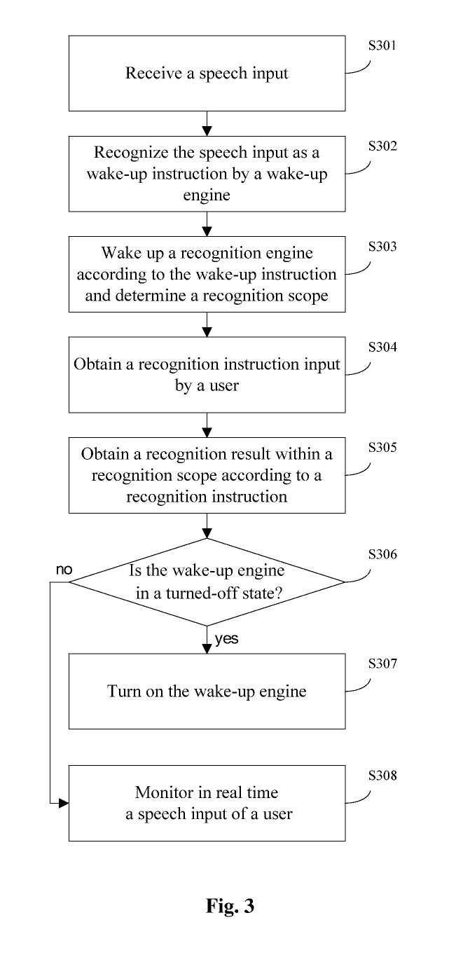

Another embodiment of the present disclosure provides a speech recognition method applied to an electronic apparatus. As shown in FIG. 3, the method includes steps S301-S308.

S301: receiving speech input.

For example, a user's speech input of “I want to watch movie” is received.

S302: recognizing the speech input as a wake-up instruction by a wake-up engine.

It shall be noted that, in a case where the speech input is a preset password, it may be recognized as a wake-up instruction. For example, “I want to watch movie” may be recognized as a wake-up instruction. In a case where the speech input is not the preset password, for example, chat contents between users, the speech input will not be recognized as a wake-up instruction. That is, the user's speech input may be monitored in real time, and in a case where the speech input is a preset password, it can be recognized as the wake-up instruction.

S303: waking up a recognition engine according to the wake-up instruction to enable the recognition engine to determine a recognition scope which corresponds to the wake-up instruction and includes M recognition items, where the recognition engine includes N recognition items, M is smaller than N, and M and N are integers larger than or equal to one.

When the wake-up instruction is a first wake-up instruction, the recognition engine determines a first recognition scope which corresponds to the first wake-up instruction and includes M1 recognition items.

When the wake-up instruction is a second wake-up instruction, the recognition engine determines a second recognition scope which corresponds to the second wake-up instruction and includes M2 recognition items, where both M1 and M2 are integers smaller than N.

S304: acquiring a recognition instruction input by a user.

In this embodiment, the recognition speech input by a user is the name of the target that the user wants to obtain, such as “Infernal Affairs”.

The recognition speech input by a user may be acquired from the speech input received in S301, or may also be a user input directly received through an audio acquisition device. In the first case, the speech input by a user in S301 includes a wake-up instruction and a recognition instruction. For example, speech input of a user “I want to watch movie Infernal Affairs” is received, in which “I want to watch movie” is recognized as a wake-up instruction and “Infernal Affairs” is recognized as a recognition instruction. In this case, the received speech input of the user may be deemed as a sentence, and the user inputs the wake-up instruction and the recognition instruction at the same time. In the second case, the speech input by a user in S301 includes only a wake-up instruction, and the user further inputs a recognition instruction after inputting the wake-up instruction. For example, a user firstly inputs a speech “I want to watch movie”, and further inputs a speech “Infernal Affair” after a pause. In this case, the received speech input of the user may be deemed as two sentences. That is, the user inputs a wake-up instruction and a recognition instruction separately.

In the first case, S304 may be executed before S302, which shall not be limited here.

S305: obtaining, according to the recognition instruction, a recognition result within a recognition scope which corresponds to the wake-up instruction and includes M recognition items.

Preferably, after S305, the method may further include:

S306: determining whether the wake-up engine is in a turned-off state; in a case where the wake-up engine is in the turned-off state, executing S307; else, executing S308.

S307: turning on the wake-up engine.

S308: monitoring a speech input of the user in real time.

The operation for turning on or turning off the wake-up engine in this embodiment and the aforesaid embodiments can be controlled either by a hardware switch or by an instruction belonging to a software category, which shall not be limited here.

An intelligent TV set is further taken as an example in the following for illustrations of the speech recognition method provided in this embodiment.

The intelligent TV set receives a user's speech input of “I want to watch movie”, recognizes “I want to watch movie” as a wake-up instruction by a wake-up engine, wakes up a recognition engine according to the wake-up instruction, and determines a recognition scope corresponding to “movie”. The intelligent TV set further receives a user's speech input of “Internal Affairs” and recognizes recognition items corresponding to “Internal Affairs” within the determined recognition scope.

Alternatively, the intelligent TV set receives a user's speech input of “I want to watch movie Internal Affairs”, recognizes “I want to watch movie” as a wake-up instruction by a wake-up engine, wakes up a recognition engine according to the wake-up instruction, and determines a recognition scope corresponding to “movie”, and acquires the recognition instruction “Internal Affairs” from “I want to watch movie Internal Affairs”, and recognizes recognition items corresponding to “Internal Affairs” within the determined recognition scope.

Alternatively, the intelligent TV set receives a user's speech input of “I want to listen to music Internal Affairs”, recognizes “I want to listen to music” as a wake-up instruction by a wake-up engine, wakes up a recognition engine according to the wake-up instruction, determines a recognition scope corresponding to the “music”, acquires the recognition instruction “Internal Affairs” from “I want to listen to music Internal Affairs”, and recognizes the recognition items corresponding to “Internal Affairs” within the determined recognition scope.

It shall be noted that the recognition scope corresponding to “movie” is different from the recognition scope corresponding to “music”, and thus the recognized recognition items are also different. In a case where the speech input is “I want to watch movie Internal Affairs”, a movie named “Internal Affairs” may be recognized; while in a case where the speech input is “I want to listen to music Internal Affairs”, music of the movie named “Internal Affairs” may be recognized.

In the existing speech recognition method, only a user's unified wake-up speech such as a “speech assistant” can be received. After waking up a recognition engine, a wake-up engine may acquire a user's recognition instruction such as “Internal Affairs”, and perform recognition within all the recognition items of the recognition engine according to the recognition instruction, and recognize all the content relevant to “Internal Affairs”, including video and audio.

Thus, compared with that in the prior art, the recognition scope in the speech recognition method described in this embodiment can be narrowed to a specific area, and thus the recognition items are decreased, the recognition efficiency can be improved, the recognition precision can be improved, and recognition results can meet the user's requirement even better.

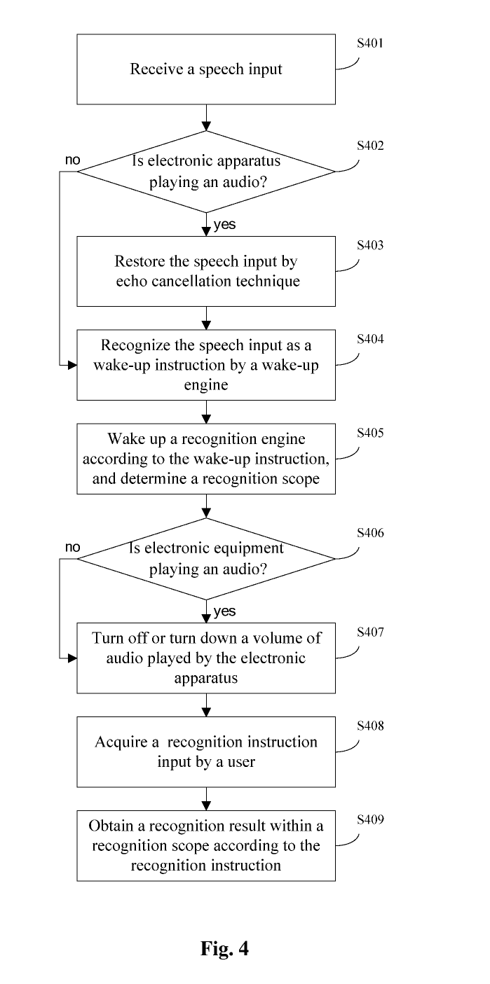

Another embodiment of the present disclosure provides a speech recognition method applied to an electronic apparatus. As shown in FIG. 4, the method includes steps S401-S409.

S401: receiving a speech input.

S402: determining whether the electronic apparatus is playing an audio; and in a case where the electronic apparatus is playing the audio, executing S403; else executing S404.

S403: restoring the speech input by echo cancellation technique.

Echo cancellation technique refers to occupying the lines in both directions of two-wire transmission simultaneously at the same frequency spectrum. Signals transmitted in both directions of the line are completely mixed. Thus, the echo of the transmitted signal at a terminal becomes an interference to the received signal at the terminal. The echo can be cancelled by an adaptive filter to obtain the received signal with a good quality.

In short, in this embodiment, echo cancellation technique refers to that the electronic apparatus utilizes the audio transmitted by the electronic apparatus to cancel the audio transmitted by the electronic apparatus from an audio mixed with the received speech input and the audio transmitted by the electronic apparatus, so as to restore the speech data.

Echo cancellation technique is utilized to avoid an interference of the audio played by a speaker of the electronic apparatus to the speech input, which lays a foundation for the subsequent speech recognition, and guarantees the precision of speech recognition.

S404: recognizing the speech input as a wake-up instruction by a wake-up engine.

S405: waking up a recognition engine according to the wake-up instruction, to enable the recognition engine to determine a recognition scope which corresponds to the wake-up instruction and includes M recognition items. The recognition engine includes N recognition items, M is smaller than N, the M and N are integers larger than one.

When the wake-up instruction is a first wake-up instruction, the recognition engine determines a first recognition scope which corresponds to the first wake-up instruction and includes M1 recognition items.

When the wake-up instruction is a second wake-up instruction, the recognition engine determines a second recognition scope which corresponds to the second wake-up instruction and includes M2 recognition items, where both M1 and M2 are integers smaller than N.

S406: determining whether the electronic apparatus is playing an audio, and in a case where the electronic apparatus is playing the audio, executing S407; else, executing S408.

S407: turning off or turning down the volume of the audio played by the electronic apparatus.

The reception of the recognition instruction may be affected in a case where the electronic apparatus is playing audio during the speech recognition. Therefore, it is necessary to turn off or turn down the volume of the electronic apparatus to improve the recognition efficiency.

S408: acquiring a recognition instruction input by a user.

S409: obtaining a recognition result within the recognition scope which corresponds to the recognition instruction and includes M recognition items.

For example, the intelligent TV set receives a speech input “I want to watch movie”, and determines that an audio is played by the speaker. In this case, the intelligent TV set restores the speech input “I want to watch movie” by echo cancellation technique, recognizes it as a wake-up instruction by a wake-up engine, wakes up a recognition engine according to the wake-up instruction, and determines a recognition scope. In a case where the intelligent TV set determines that the audio is still played by the speaker after waking up the recognition engine, the intelligent TV set turns off or turns down the volume of the audio played by the speaker to avoid interference to the speech input by a user. When the speech “Internal Affairs” is further received, the recognition items corresponding to “Internal Affairs” are recognized within the determined scope.

Compared with the aforesaid embodiment, with the speech recognition method described in this embodiment, it is determined whether the electronic apparatus is playing an audio after the speech input is received. In a case where the electronic apparatus is playing an audio, the speech input is restored by echo cancellation technique. The wake-up of the recognition engine means that a speech recognition instruction will soon be acquired. It is determined again whether the electronic apparatus is playing an audio. In a case where the electronic apparatus is playing the audio, the volume of the audio is turned off or turned down. The electronic apparatus may precisely detect speech input by a user even when the electronic apparatus is playing audio, by using the echo cancellation technique. By turning off or turning down the volume of the audio after the recognition engine is waken up, the precision of speech recognition may be guaranteed in the largest extent.

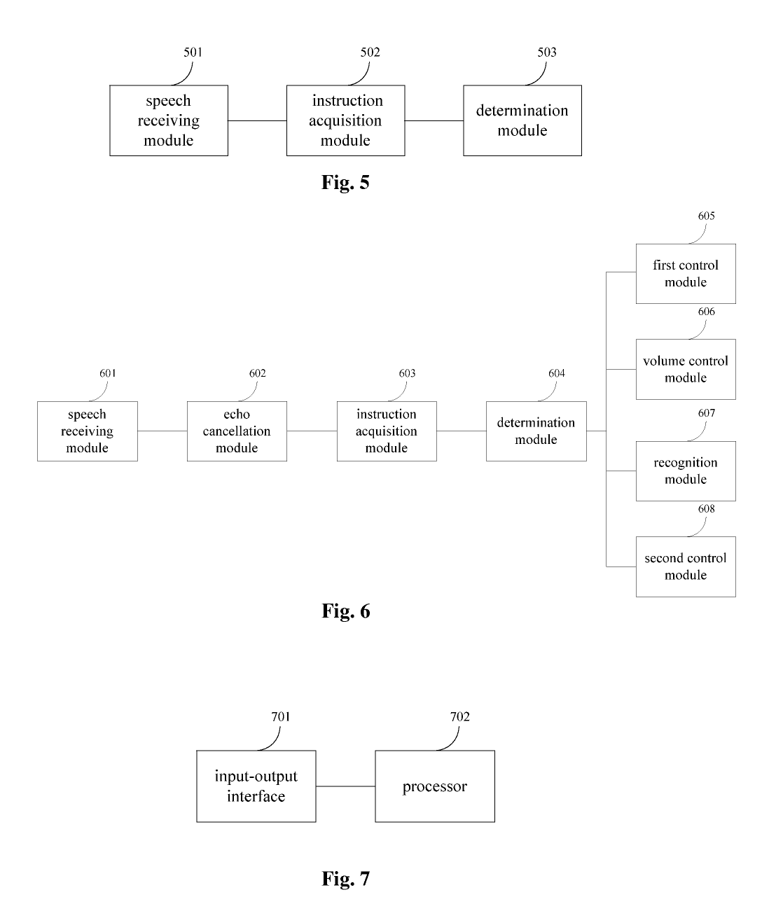

Corresponding to the method embodiments described above, an embodiment of the present disclosure provided a speech recognition device applied to an electronic apparatus. As shown in FIG. 5, the speech recognition device includes a speech receiving module 501, an instruction acquisition module 502, and a determination module 503.

The speech receiving module 501 is adapted to receive a speech input.

The instruction acquisition module 502 is adapted to recognize the speech input as a wake-up instruction by a wake-up engine.

The determination module 503 is adapted to wake up a recognition engine according to the wake-up instruction to enable the recognition engine to determine a recognition scope which corresponds to the wake-up instruction and includes M recognition items, where the engine includes N recognition items, M is smaller than N, and the M and N are integers larger than or equal to one.

When the wake-up instruction is a first wake-up instruction, the recognition engine determines a first recognition scope which corresponds to the first wake-up instruction and includes M1 recognition items.

When the wake-up instruction is a second wake-up instruction, the recognition engine determines a second recognition scope which corresponds to the second wake-up instruction and includes M2 recognition items, where both M1 and M2 are integers smaller than N.

The process of speed recognition by speech recognition device described in this embodiment includes: receiving a user's speech input, such as “I want to read novel”, recognizing the speech input as a wake-up instruction by a wake-up engine, waking up a recognition engine according to the wake-up instruction to enable the recognition engine to determine a recognition scope corresponding to “novel” among all the recognition items. In this way, the recognition scope is narrowed, and therefore the precision of speech recognition may be improved.

Another embodiment of the present disclosure provides a speech recognition device. As shown in FIG. 6, the speech recognition device includes a speech receiving module 601, an echo cancellation module 602, an instruction acquisition module 603, a determination module 604, a first control module 605, a volume control module 606, a recognition module 607, and a second control module 608.

The speech receiving module 601 is adapted to receive a speech input.

The echo cancellation module 602 is adapted to restore the speech input by echo cancellation technique in a case where the electronic apparatus is playing an audio when receiving the speech input.

The instruction acquisition module 603 is adapted to recognize the speech input as a wake-up instruction by a wake-up engine.

The determination module 604 is adapted to wake up a recognition engine according to the wake-up instruction to enable the recognition engine to determine a recognition scope which corresponds to the wake-up instruction and includes M recognition items, where the engine includes N recognition items, M is smaller than N, and M and N are integers larger than or equal to one.

When the wake-up instruction is a first wake-up instruction, the recognition engine determines a first recognition scope which corresponds to the first wake-up instruction and includes M1 recognition items.

When the wake-up instruction is a second wake-up instruction, the recognition engine determines a second recognition scope which corresponds to the second wake-up instruction and includes M2 recognition items, where both M1 and M2 are integers smaller than N.

The first control module 605 is adapted to turn off the wake-up engine after a recognition engine is waked up according to the wake-up instruction.

The volume control module 606 is adapted to turn off or turn down the volume of the audio played by the electronic apparatus in a case where the electronic apparatus is playing an audio after the recognition engine is waken up according to the wake-up instruction.

The recognition module 607 is adapted to acquire a recognition instruction input by a user, and obtain a recognition result within a recognition scope which corresponds to the wake-up instruction and includes M recognition items.

The second control module 608 is adapted to turn on a wake-up engine in the case that the wake-up engine is in a turned-off state.

In the speech recognition device described in this embodiment, the echo cancellation module, the first control module, the volume control module, the recognition module and the second control module are all preferable modules. The speech recognition device may narrow the recognition scope to improve the precision and efficiency of recognition.

Another embodiment of the present disclosure provides an electronic apparatus.

As shown in FIG. 7, the electronic apparatus includes an input-output interface 701 and a processor 702.

The input-output interface 701 is adapted to receive a speech input.

The processor 702 is adapted to recognize the speech input as a wake-up instruction by a wake-up engine, and wake up a recognition engine according to the wake-up instruction to enable the recognition engine to determine a recognition scope which corresponds to the wake-up instruction and includes M recognition items, where the engine includes N recognition items, M is smaller than N, and both M and N are integers larger than or equal to one.

When the wake-up instruction is a first wake-up instruction, the recognition engine determines a first recognition scope which corresponds to the first wake-up instruction and includes M1 recognition items.

When the wake-up instruction is a second wake-up instruction, the recognition engine determines a second recognition scope which corresponds to the second wake-up instruction and includes M2 recognition items, where both M1 and M2 are integers smaller than N.

The electronic apparatus may be an intelligent TV set, a PC, a PAD, or a mobile communication terminal, etc.

The electronic apparatus described in this embodiment, during the process of speech recognition according to speech input, determines a recognition scope corresponding to the wake-up instruction according to the wake-up instruction. Therefore, the recognition scope, compared with all the recognition items of the recognition engine, is narrowed, and the recognition precision is improved.

When functions of the method according to this embodiment are implemented in a form of software function unit and are sold or used as a separate product, those can be stored in a computer readable storage medium. Based on the above understanding, parts of the embodiments of the disclosure which contribute to the prior art or part of the technical solution can be embodied as a software product stored in a storage medium which includes a number of instructions for causing a computing device (which may be a personal computer, a server, a mobile computing device, a network device, etc.) to perform all or some of the steps in the methods according to various embodiments of the disclosure. The storage medium includes various media capable of storing program codes, such as U disk, mobile hard disk, ROM (Read-Only Memory), RAM (Random Access Memory), magnetic disk, or optical disk.

The embodiments of the present disclosure are described herein in a progressive manner, each of which emphasizes the differences from others; hence for the same or similar parts between the embodiments, one can refer to the other embodiments.

The description of the embodiments herein enables those skilled in the art to implement or use the disclosure. Numerous modifications to the embodiments will be apparent to those skilled in the art, and the general principle herein can be implemented in other embodiments without departing from the spirit or scope of the disclosure. Therefore, the present disclosure shall not be limited to the embodiments described herein, but shall cover the widest scope consistent with the principle and novel features disclosed herein.

1. A speech recognition method applied to an electronic apparatus, comprising:
receiving a speech input;
recognizing the speech input as a wake-up instruction by a wake-up engine;
waking up a recognition engine according to the wake-up instruction, wherein the recognition engine is adapted to determine a recognition scope which corresponds to the recognition instruction and comprises M recognition items, wherein the recognition engine comprises N recognition items, M is smaller than N, and both M and N are integers larger than or equal to one,
wherein in the case that the wake-up instruction is a first wake-up instruction, the recognition engine determines a first recognition scope which corresponds to the first wake-up instruction and comprises M1 recognition items; and
in the case that the wake-up instruction is a second wake-up instruction, the recognition engine determines a second recognition scope which corresponds to the second wake-up instruction and comprises M2 recognition items, wherein both M1 and M2 are integers smaller than N.

2. The method according to claim 1, wherein after waking up a recognition engine according to the wake-up instruction, the method further comprises:
turning off the wake-up engine.

3. The method according to claim 1, further comprising:
acquiring a recognition instruction input by a user; and
obtaining, according to the recognition instruction, a recognition result within the recognition scope which corresponds to the wake-up instruction and comprises M recognition items.

4. The method according to claim 3, wherein after obtaining the search result, the method further comprises:
turning on the wake-up engine in the case that the wake-up engine is in a turned-off state.

5. The method according to claim 1, further comprising:
restoring the speech input by echo cancellation technique in a case where the electronic apparatus is playing an audio when receiving the speech input; and
turning off or turning down a volume of the audio played by the electronic apparatus in the case that the electronic apparatus is playing the audio after waking up the recognition engine according to the wake-up instruction.

6. The method according to claim 1, wherein the recognition engine comprises:
a local recognition engine; or
a cloud recognition engine.

7. A speech recognition device applied to an electronic apparatus, comprising:
a speech receiving module adapted to receive a speech input;
an instruction acquisition module adapted to recognize the speech input as a wake-up instruction by a wake-up engine; and
a determination module adapted to wake up the recognition engine according to the wake-up instruction, wherein the recognition engine is adapted to determine a recognition scope which corresponds to the wake-up instruction and comprises M recognition items, wherein the recognition engine comprises N recognition items, M is smaller than N, the M and N are integers larger than or equal to one,
wherein in the case that the wake-up instruction is a first wake-up instruction, the recognition engine determines a first recognition scope which corresponds to the first wake-up instruction and comprises M1 recognition items; and
in the case that the wake-up instruction is a second wake-up instruction, the recognition engine determines a second recognition scope which corresponds to the second wake-up instruction and comprises M2 recognition items, wherein both M1 and M2 are integers smaller than N.

8. The device according to claim 7, further comprising:
a first control module adapted to turn off the wake-up engine after the recognition engine is waked up according to the wake-up instruction.

9. The device according to claim 7, further comprising:
a recognition module adapted to acquire a recognition instruction input by a user; and obtain, according to the recognition instruction, a recognition result within the recognition scope which corresponds to the wake-up instruction and comprises M recognition items.

10. The device according to claim 9, further comprising:
a second control module adapted to turn on the wake-up engine in the case that the wake-up engine is in a turned-off state.

11. The device according to claim 7, further comprising:
an echo cancellation module adapted to restore the speech input by echo cancellation technique in the case that the electronic apparatus is playing an audio when receiving the speech input;
A volume control module adapted to turn off or turn down a volume of the audio played by the electronic apparatus in the case that the electronic apparatus is playing the audio after the recognition engine is waken up according to the wake-up instruction.

12. An electronic apparatus, comprising:
an input-output interface adapted to receive a speech input; and
a processor adapted to recognize the speech input as a wake-up instruction by a wake-up engine, and wake up the recognition engine according to the wake-up instruction, wherein the recognition engine is adapted to determine a recognition scope which corresponds to the wake-up instruction and comprises M recognition items, wherein the recognition engine comprises N recognition items, M is smaller than N, and the M and N are integers greater than or equal to one,
wherein in the case that the wake-up instruction is a first wake-up instruction, the recognition engine determines a first recognition scope which corresponds to the first wake-up instruction and comprises M1 recognition items; and
in the case that the wake-up instruction is a second wake-up instruction, the recognition engine determines a second recognition scope which corresponds to the second wake-up instruction and comprises M2 recognition items, wherein both M1 and M2 are integers smaller than N.
